(19) United States
(12) Patent Application Publication
(10) Pub. No.: US 2015/0106181 A1
(43) Pub. Date: Apr. 16, 2015

(54) METHOD AND SYSTEM FOR PROVIDING A COUPON DURING AN ONLINE CHECKOUT PROCESS

(71) Applicant: COUPONCABIN LLC, Whiting, IN (US)

(72) Inventor: Scott E. Kluth, Streamwood, IL (US)

(73) Assignee: COUPONCABIN LLC, Whiting, IN (US)

(21) Appl. No.: 14/515,007

(22) Filed: Oct. 15, 2014

Related U.S. Application Data
(60) Provisional application No. 61/891,221, filed on Oct. 15, 2013.

(51) Int. Cl. G06Q 30/02

(52) U.S. Cl. CPC G06Q 30/0222; G06Q 30/0224
USPC 705/14.23

(57) ABSTRACT

During a checkout process of an online sale transaction, a web page of a retailer website may display a shopping cart application that includes selected product objects and a clickable coupon service object. A user may activate or click the coupon service object. Upon activating the coupon service object, a coupon object associated with at least one of the selected product objects of the shopping cart application may be determined and a coupon code may be retrieved from the determined coupon object. The retrieved coupon code may be displayed on the web page to allow the user to view, select and apply the retrieved coupon code associated with the selected product object of the shopping cart application during a checkout.

### CROSS-REFERENCE TO RELATED APPLICATIONS

The present application claims the benefit of U.S. Provisional Application No. 61/891,221 filed on Oct. 15, 2013, the disclosure of which is incorporated herein by reference in its entirety for all purposes.

### TECHNICAL FIELD

The present disclosure generally relates to a system and method for providing a coupon service during an online checkout process which enables a provider of online coupons to present relevant coupons to a user during the checkout process.

### BACKGROUND

Online retailers have employed various methods to draw customers to their websites, including methods that have their origin in traditional, “brick and mortar” sales transactions. One method is the use of discounts in the form of coupons. Traditional coupons are offered to a potential customer through printed circulars, newspaper supplements, magazine advertisements, etc., and usually offer some sort of discount off of the regular sale price of an item. Bar codes on the printed coupons allow the retailer and manufacturer to track various information about the sale including the origin of the printed coupon (i.e., the newspaper, magazine, or other physical source of the coupon). By tracking information about the source of the coupon, the retailer or manufacturer may also provide a commission from the sale of the item to the coupon publisher as motivation to publish future coupons.

Coupons are also used in online sales transactions. Sales commissions may be earned by entities that publish, aggregate, and maintain online coupon codes or discount links through affiliate marketing. In an affiliate marketing relationship, a retailer or other online business rewards one or more third parties or “affiliates” for a sale transaction that originates by the affiliate's marketing efforts. Affiliate marketing typically includes four entities: a retailer, an affiliate network, a publisher or affiliate, and a customer. Affiliate networks partner with publishers who provide online coupon codes or discount links to help draw more customers to the retailers. In essence, a retailer will pay a sales commission to one or more of the affiliate network and the affiliate for directing potential customers to the retailer's website to complete a sale transaction.

The affiliate network and affiliate are able to realize a sales commission if the retailer is able to directly credit a sale to those entities. The retailer, affiliate network, and affiliate are able to track the origin of the sale by using web browser cookies or other means. Typically, a user visits an affiliate's website (e.g., CouponCabin.com) by entering the affiliate's URL directly into the user's browser, by a search engine, by following a link in an email, etc. The user may find a coupon code or discount link for a retailer and then select or click that link or code that includes a request URL. Selecting the coupon or link sends the user's browser to the affiliate network's server along with an identifying code contained in the request URL indicating that the affiliate was the referral source. The affiliate network's server/redirector sets a cookie on the user's computer that identifies the affiliate and the affiliate network to the retailer. The user's browser then redirects to the retailer's website. The user shops at the retailer's website and as part of the checkout process, the customer may enter the coupon code in an appropriate field. Upon completion, the sale is logged to a server at the affiliate network and the affiliate network reports the completed transaction back to its source: the affiliate. The affiliate may earn a percentage commission on the sale according to terms agreed to with the retailer because the retailer was able to identify the affiliate from the information included in the cookie.

When a user is shopping at the retailer's website, the user may be interested in entering coupon codes into the appropriate field at the checkout web page to receive discounts. However, in order to enter the coupon codes, the user may need to perform a search for the relevant coupon codes, a process that can be inconvenient and time consuming for the user.

### SUMMARY

In some embodiments, a method for providing a coupon service on a retailer website during a checkout process of an online sale transaction includes activating a clickable coupon service object included in a shopping cart application displayed on a web page of the retailer website. The method further includes determining one or more selected product objects listed in the shopping cart application and communicating with a coupon hosting system to determine a coupon object associated with at least one of the selected product objects of the shopping cart application. Additionally, the method includes receiving the determined coupon object from the coupon hosting system and retrieving a coupon code corresponding to the determined coupon object.

In other embodiments, a coupon providing system configured to provide a coupon service on a retailer website during a checkout process of an online sale transaction comprises a program memory, a processor, and a shopping cart application that includes selected product objects and a clickable coupon service object that is stored in the program memory and displayed on a web page of the retailer website. The clickable coupon service object when activated causes the processor to determine one or more selected product objects listed in the shopping cart application and communicate with a coupon hosting system to determine a coupon object associated with at least one of the selected product objects of the shopping cart application. Further, the clickable coupon service object when activated causes the processor to receive the determined coupon object from the coupon hosting system and retrieve a coupon code corresponding to the determined coupon object.

In still other embodiments, a non-transitory computer-readable storage medium comprising computer-executable instructions to be executed on one or more processors of a system for providing a coupon service on a retailer website during a checkout process of an online sale transaction, the instructions when executed causes the one or more processors to activate a clickable coupon service object included in a shopping cart application displayed on a web page of the retailer website and determine one or more selected product objects listed in the shopping cart application. Further, the instructions when executed causes the one or more processors to communicate with a coupon hosting system to determine a coupon object associated with at least one of the selected product objects of the shopping cart application. Additionally, the instructions when executed causes the one or more processors to receive the determined coupon object from the coupon hosting system and retrieve a coupon code from the determined coupon object.

### BRIEF DESCRIPTION OF THE DRAWINGS

The figures described below depict various aspects of the system and methods disclosed herein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 illustrates an exemplary block diagram of a computer network and system on which an exemplary coupon providing system and method may operate to provide a coupon service during a checkout process in accordance with the described embodiments;

FIG. 2 illustrates an exemplary flow chart of a method for providing a coupon service during a checkout process;

FIG. 3 illustrates an exemplary screen shot of a retailer checkout web page that provides a coupon service;

FIG. 4 illustrates an exemplary flow chart of a method for executing a coupon displaying process after activating a coupon service during a checkout process;

FIGS. 5A, 5B, 5C, and 5D are block diagrams of data structures used in the system and method to provide a coupon service during a checkout process in accordance with the described embodiments; and

FIG. 6 is a block diagram of a computing system that implements a coupon providing system and method to provide a coupon service during a checkout process.

### DETAILED DESCRIPTION

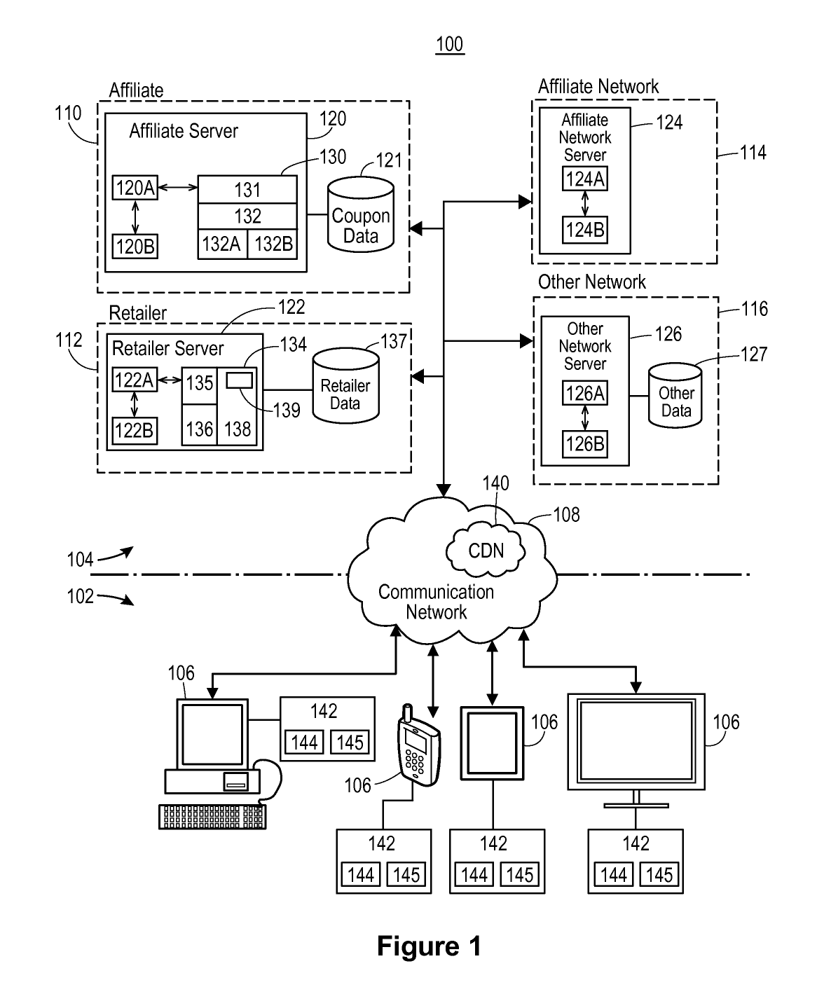

FIG. 1 illustrates various aspects of an exemplary architecture that implements a coupon providing system 100 as a specialized computing system. The high-level architecture includes both hardware and software applications, as well as various data communications channels for communicating data between the various hardware and software components.

The coupon providing system 100 may be roughly divided into front-end components 102 and back-end components 104. The front-end components 102 are primarily web-enabled devices 106 (personal computers, smart phones, tablets, televisions, etc.) connected to a communication network 108 by one or more users. The web-enabled devices 106 may be located, by way of example rather than limitation, in separate geographic locations from each other, including different areas of the same city, different cities, or even different states or countries.

The front-end components 102 communicate with the back-end components 104 via the communication network 108. The communication network 108 may be, for example, a proprietary network, a secure public Internet, a LAN, a virtual private network or some other type of network, such as dedicated access lines, plain ordinary telephone lines, satellite links, combinations of these, etc. If the communication network 108 comprises the Internet, data communication may take place over the network 108 via an Internet communication protocol. The back-end components 104 include a coupon hosting system or affiliate 110 (e.g., a publisher of coupons such as CouponCabin.com, or other Internet-based publicly-accessible system that publishes or hosts coupons), a retailer 112, an affiliate network 114, and other network 116.

The affiliate 110 may include one or more servers 120, each of which includes a memory 120A to store various information, software applications, modules, functions, routines, instructions, etc., and a processor or controller 120B to execute the various applications, modules, functions, routines, instructions, etc. The affiliate 110 further includes a coupon database 121, which is configured to store data such as coupon codes, discount uniform resource locators (URLs), and other content. The affiliate 110 may access the data stored in the coupon database 121 when executing various functions and tasks associated with the operation of the system 100, as described herein.

Both the retailer 112 and the affiliate network 114 may include one or more servers 122, 124, respectively. Each of the servers 122, 124 includes a memory 122A, 124A to store information, applications, modules, routines, instructions, etc., and a processor or controller 122B, 124B to execute the applications, modules, routines, instructions, etc. The retailer server(s) 122 may be used to facilitate an online purchase transaction, while the affiliate network server(s) 124 may be used to identify the affiliate 110 to the retailer 112.

The other network 116 may host other data such as personal data or user-generated data (e.g., a user's interests, preferences, likes/dislikes, habits, profiles, etc.). The other network 116 may be, for example, a social media network, a blogging network, a customer review site, etc. The other network 116 may include one or more servers 126 connected to one or more other databases 127. Each of the servers 126 includes a memory 126A that stores applications, routines, instructions, etc., and a processor or controller 126B that executes the applications, routines, instructions, etc. Each of the databases 127 is configured to store the other data, which the network 116 may access when executing various functions and tasks associated with the operation of the system 100, as further described herein.

Although the coupon providing system 100 is shown to include the affiliate 110 in communication with the retailer 112, the affiliate network 114, the other network 116 and four web-enabled devices 106, it should be understood that different numbers of processing systems, specialized computers, retailers, affiliate networks, other networks, and web-enabled devices may be utilized. For example, the communication network 108 may interconnect the system 100 to a plurality of affiliates 110, retailers 112, affiliate networks 114 and other networks 116, and a vast number of web-enabled devices 106. Generally speaking, the affiliate 110, the retailer 112, the affiliate network 114 and the other network 116 may have various different structures and methods of operation. It should also be understood that while the embodiment shown in FIG. 1 illustrates some of the components and/or data connections that may be present in an exemplary design of an affiliate, a retailer, an affiliate network or other network, the embodiment in FIG. 1 does not illustrate all of the components and/or data connections that may be present and numerous other designs may be utilized.

As shown in FIG. 1, the affiliate 110 may host an affiliate website 130. Coupon data and objects 131, 132 may be retrieved from the coupon database 121 and displayed in the affiliate website 130. In one embodiment, the coupon object 132 may be a clickable object. The clickable object 132 may be any type of static or dynamic object that may include a graphic portion 132A and a plurality of instructions 132B. A user may click on the object 132 as represented by the graphic portion 132A to execute the object 132. When executed, the plurality of instructions 132B may call functions that cause the processor 120B to perform various calculations, access local or remote data sources, execute local or remote functions, etc. In general, the graphic portion 132A and the plurality of instructions 132B of the clickable object 132 may include configurable properties that determine how the clickable object 132 is displayed and what function may be called when the user clicks on the object 132.

In some embodiments, the clickable object 132 is a JavaScript browser object (e.g., a button object, an area object, a text object, etc.) stored within the affiliate 110 and delivered to the web-enabled devices 106 via the communication network 108 in response to a user request. For example, a user attempting to access the affiliate website 130 on one of the devices 106 may open a web browser and enter a URL or other information that requests data from the affiliate 110. The requested data sent to one of the devices 106 may then include the clickable object 132.

The retailer 112 may similarly host a retailer website 134, which may display retailer data and objects 135, 136 retrieved from a retailer database 137. The database 137 is configured to store data related to various products or items offered by the retailer 112. The retailer website 134 may include a coupon service object 138. The object 138 may be clickable like the clickable object 132. Activating the clickable coupon service object 138 allows the user to view and select various coupon codes 139 at the retailer website 134 or at another website such as the affiliate website 130.

As generally known in the art, clickable objects (e.g., the clickable objects 132, 138) may include text (some of which may serve as links and URLs to additional information and other websites), buttons, data entry boxes or text fields, pull-down lists, radio buttons, check boxes, and images. Throughout this specification, it is assumed that the clickable objects refer to graphic elements that a user may activate using a mouse or other pointing device. Thus, throughout the specification, the terms “click” and “clicking” may be used interchangeably with the terms “select,” “activate,” or “submit” to indicate the selection or activation of one of the buttons or other display elements. Of course, other methods (e.g., keystrokes, voice commands, etc.) may also be used to select or activate the clickable objects. Moreover, throughout this specification, the terms “link” and “button” are used interchangeably to refer to a graphic representation of a command that may call a method, function, or function block (i.e., the various “block #” as described below) including one or more instructions that are executed by a processor or controller by clicking on the command.

While FIG. 1 only depicts the objects 131, 132, 135, 136 and 138 in the websites 130 and 134, the websites 130 and 134 in general may include any number of objects. Further, while FIG. 1 depicts the websites 130, 134 as separate from the memories 120A, 122A, respectively, the websites 130, 134 may be stored in the memories 120A, 122A, respectively, stored remotely from the affiliate 110 and/or retailer 112, or stored as part of a content delivery network (CDN) 140 located at various points in the communication network 108.

Additionally, various software applications and functions resident in the back-end components 104 provide various user interface methods to allow users (i.e., shoppers and other parties to an online sale transaction, etc.) to access the system 100. One or more of the back-end components 104 may also include various video, image, and graphic design applications to permit the implementation of the websites 130 and 134. In one example implementation, the retailer 112 may design a website (e.g., the retailer website 134) that includes a shopping cart software application, which allows a shopper to complete a checkout process during an online shopping session. The shopping cart application may provide a coupon service (e.g., in the form of a coupon service object such as the object 138), which when activated, allows the shopper to access various coupons from the affiliate 110, the retailer 112, or any other entity during the checkout process.

For the front-end components 102, each of the web-enabled devices 106 may include a user interface application that may be a web browser 142 (e.g., Microsoft Internet Explorer, Mozilla Firefox, Google Chrome, etc.) for accessing the affiliate 110, the retailer 112, the affiliate network 114, and the other network 116. In general, the browser(s) 142 may be any type of web browsing client, including a proprietary client, and may communicate with the servers 120, 122, 124, 126 using any type of protocol including, but not limited to, file transfer protocol (FTP), telnet, hypertext-transfer protocol (HTTP), etc. In addition, information sent to and from the servers 120, 122, 124, 126 may include data retrieved from the coupon database 121, the retailer database 137, the other databases 127, the CDN 140, and/or the memories 120A, 122A, 124A, 126A.

In some embodiments, each of the browser(s) 142 may also include or have access to one or more mechanisms (e.g., cookies 144, 145) to record transactions for an affiliate to receive credit for directing a customer to a retailer's website to conduct a sale transaction. As such, the servers 120, 122 and 124 may implement any known protocol or method adapted to the purpose of ensuring that the affiliate 110 receives credit for referring the customer to the retailer 112 to complete a sale transaction.

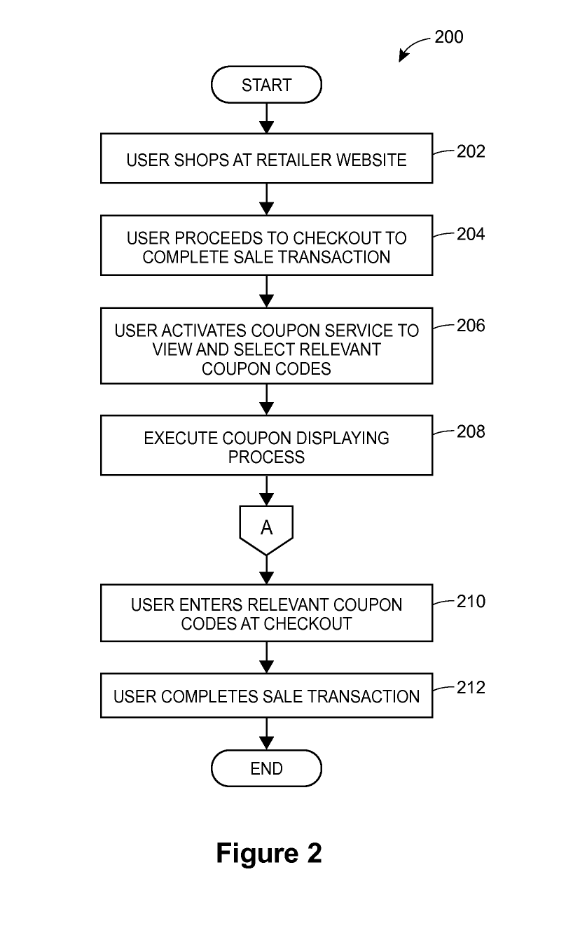

FIG. 2 illustrates one embodiment of a method 200 for providing a coupon service during a checkout process of an online sale transaction. At block 202, a user may visit a retailer (e.g., the retailer 112) via a retailer website (e.g., the retailer website 134) to shop for products or items offered by the retailer. The retailer website may include a plurality of web pages each made up of a plurality of objects (e.g., the objects 135, 136, 138) formatted using a hypertext language such as HTML, XHTML, etc., and may provide navigation to other web pages via hypertext links.

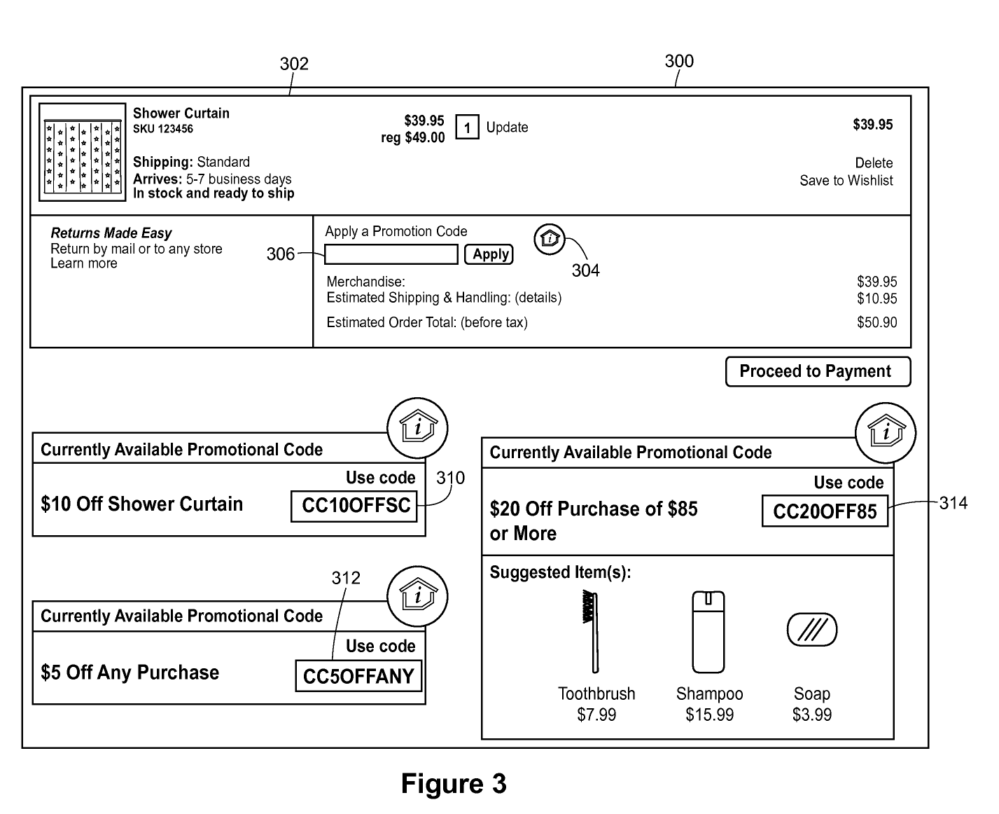

At block 204, the user finishes shopping and proceeds to complete the checkout process. To this end, the retailer website may include a checkout web page among the plurality of web pages. The checkout web page may include a shopping cart application, which lists the products that the user has chosen to purchase, price of the products, shipping information, total cost of the transaction, etc. As an illustration, FIG. 3 shows an example checkout web page 300 for the retailer website including a shopping cart application 302. The web page 300 including the shopping cart 302 may be stored and retrieved from various memory sources (e.g., the memory 122A, the CDN 140, etc.), and served from a server (e.g., the retailer server 122) using HTTP. The web page 300 may include files of static text, or the server may construct the (X)HTML for the web page 300 when it is requested by the user's browser (i.e., dynamic web pages).

The web page 300 may also provide a coupon service object 304 (which may be similar to the object 138 from FIG. 1). The coupon service object 304 may be provided by the retailer or another entity different from the retailer (e.g., an affiliate). The coupon service object 304 may be embedded in the HTML of the web page 300, or the coupon service object 304 may be a linked download specified in the HTML of the web page 300. Further, the coupon service object 304 may be integrated as an application with the shopping cart 302.

In the embodiment of FIG. 3, the coupon service object 304 is a clickable object that is part of the shopping cart 302. The coupon service object 304 is provided by an affiliate (e.g., the affiliate 110) which publishes or hosts coupon codes for the retailer. In FIG. 3, the coupon service object 304 is in the form of an icon, but in other implementations, the coupon service object 304 may be a button, an animated graphic, a text, or any other visual element. The coupon service object 304 may be positioned in a visible area of the shopping cart 302 for easy recognition. For example, in FIG. 3, the coupon service object 304 is positioned near a coupon entry box 306, which is used for entering coupon codes that may be applied towards the sale transaction.

Returning to FIG. 2, at block 206, the user may activate or select a coupon service (e.g., activate the coupon service object 304). Generally speaking, activating the coupon service allows the user to view and select relevant coupon codes. In an embodiment, the coupon service is activated by activating the coupon service object 304, which allows relevant coupon codes (e.g., coupon codes 310-314) to appear within the web page 300. For example, when the user clicks on the coupon service object 304, the retailer 112 may send a request to the affiliate 110 to retrieve the relevant coupon codes 310-314 from a coupon database (e.g., the coupon database 121). After retrieving the relevant coupon codes 310-314, the affiliate 110 may transmit the relevant coupon codes 310-314 back to the retailer 112 to be displayed within the web page 300. In other embodiments, activating the coupon service object 304 may launch a new website or a new web page. For example, when the user clicks on the coupon service object 304, the user's browser may be redirected to the affiliate website 130 hosted by the affiliate 110. The user may then view and select the relevant coupon codes shown on the affiliate website 130. Additionally or alternatively, when the user clicks on the coupon service object 304, the affiliate website 130 may be launched and embedded within the web page 300. This allows the user to access the affiliate website 130 from within the same web page 300. In still other embodiments, the relevant coupon codes may be stored at the retailer 112. In this scenario, when the user clicks on the coupon service object 304, the relevant coupon codes may be retrieved from a retailer database (e.g., the retailer database 137) and displayed within the web page 300.

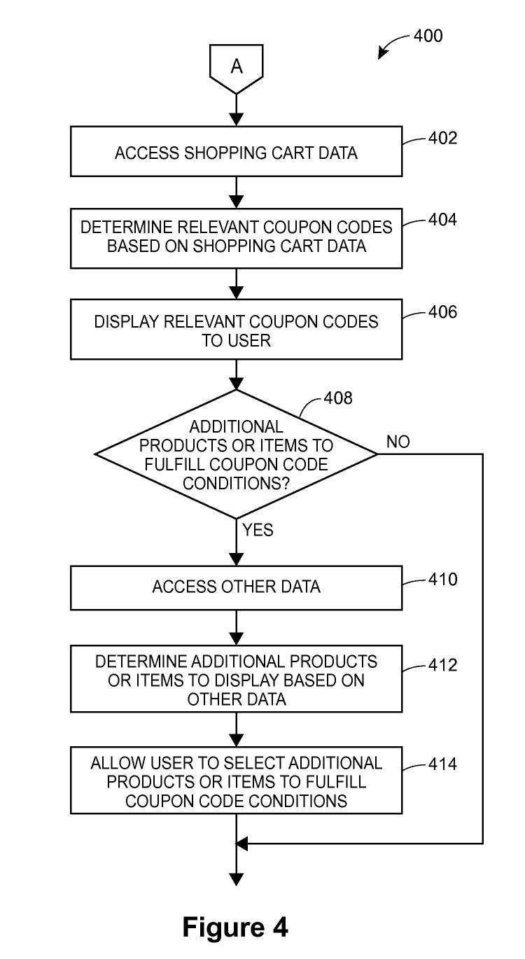

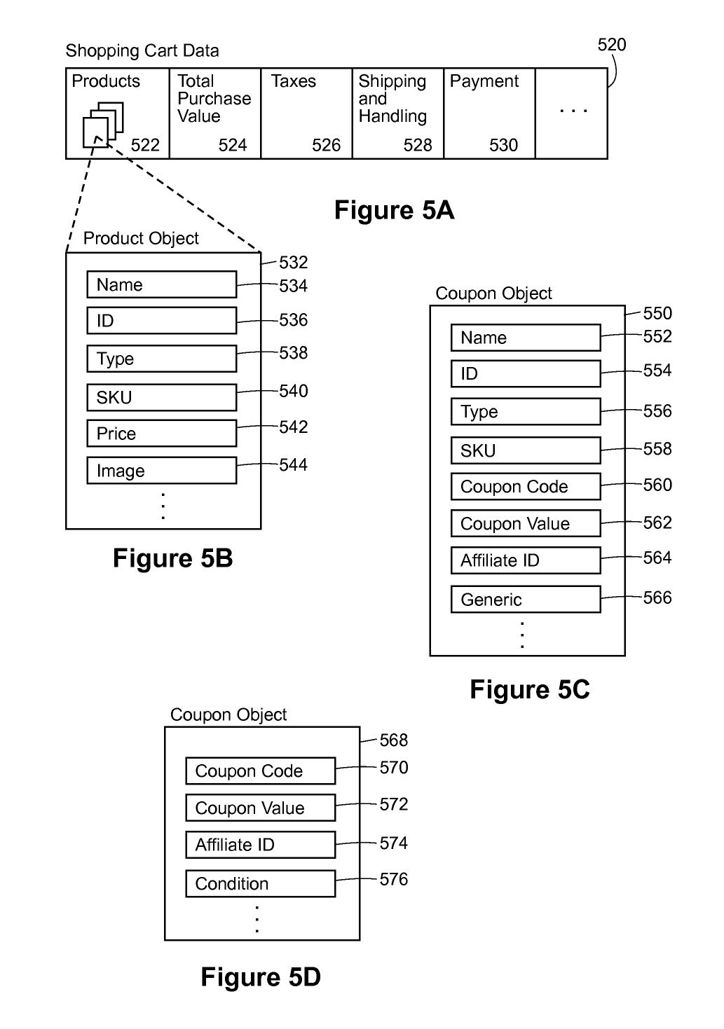

More particularly, activating the coupon service object 304 may execute a coupon displaying process at block 208, which allows the user to view and select shopping cart specific coupon codes during the checkout process. With reference to FIGS. 4 and 5A-5D, a coupon displaying process 400 may begin after the user activates or clicks on the coupon service object 304 in the shopping cart 302.

At block 402 in FIG. 4, the process 400 may access shopping cart data in the shopping cart 302. An example shopping cart data 520 is illustrated in FIG. 5A. The shopping cart data 520 may include multiple fields that describe various information such as products 522, total purchase value 524, taxes 526, shipping and handling information 528, payment information 530, etc. The products field 522 may further include one or more product objects 532 (FIG. 5B), each representing an individual product or item that the user has chosen to purchase. As such, each product object 532 may include multiple fields that describe the product or item such as a product name 534, a product identification (ID) number 536, a product type 538, a stock keeping unit (SKU) code 540, a price 542, a product image 544, etc.

At block 404 in FIG. 4, the process 400 may determine which relevant coupon codes to display based on the shopping cart data from the shopping cart 302. In an example implementation, the process 400 may determine the product objects 532 in the shopping cart data 520, and then send that information to the affiliate 110 in order to determine whether any coupon codes exist for the products represented by the product objects 532. Thus, if relevant coupon codes do exist and are available for the products, then the process 400 may receive the relevant coupon codes from the affiliate 110.

In order to determine the relevant coupon codes, the product objects 532 are compared to coupon objects that represent the relevant coupon codes stored at the affiliate 110. FIG. 5C illustrates an example coupon object 550. The coupon object 550 may represent a coupon code for a particular product or item. Thus, the product coupon object 550 may include one or more fields such as a product name 552, a product ID 554, a product type 556, a SKU code 558, etc., that can be used to relate the coupon object 550 to the particular product (i.e., the product object 532). In this manner, certain fields in a product object 532 (e.g., the fields 534-540) may be compared to certain fields in the coupon object 550 (e.g., the fields 552-558) to determine if a relevant coupon code exists for the particular product or item represented by the product object 532. When there is a positive match between the product object 532 and the product coupon object 550, then the process 400 may receive the identified coupon object 550 in order to display the relevant coupon code. As such, the coupon object 550 may include a coupon code field 560 that describes the relevant coupon code and a coupon value field 562 that describes the value of the coupon (e.g., 20% off regular price). In some embodiments, the coupon object 550 may include other fields such as an affiliate ID field 564 that allows the retailer to properly identify and credit the affiliate 110 for providing the relevant coupon code.

Alternatively or additionally, the coupon object 550 may represent a coupon code that is applicable to all (or any) of the products or items. For example, the coupon object 550 may represent a general coupon code that provides a discount to any product in the shopping cart 302. In this scenario, the coupon object 550 may include other fields such as a generic field 566 to signify that a relevant coupon code is available to all or any of the products or items.

FIG. 5D illustrates another type of coupon object 568. The coupon object 568 may include fields that are similar to the coupon object 550 such as a coupon code field 570, a coupon value field 572, an affiliate ID field 574, etc. However, the coupon object 568 may represent a coupon code that is based on the shopping cart data 520 itself. For example, the coupon object 568 may represent a coupon code that offers a free service (e.g., free shipping, free gift wrapping, etc.) if the total value of the purchase indicated in the shopping cart data 520 is greater than a predetermined threshold value. In another example, the coupon object 568 may represent a coupon code that offers a certain amount of discount (or a percentage of discount) if the total value of the purchase indicated in the shopping cart data 520 is greater than a predetermined threshold. In either case, in order to use the coupon code, a condition 576 may be stipulated. As such, the conditional coupon object 568 may include an additional field that describes a coupon condition 576 such as a predetermined threshold value. As an example implementation, the process 400 may send the shopping cart data 520 to the affiliate 110. At the affiliate 110, the total purchase value field 524 in the shopping cart data 520 may be compared to the condition 576 (e.g., a threshold value) in the coupon object 568 to determine if the total purchase value of the shopping cart satisfies the coupon condition. If the coupon condition 576 is not satisfied (i.e., the total purchase value 524 is below the threshold value), then the coupon object 568 may be identified as a relevant coupon code for the process 400 to display.

Referring back to block 406 in FIG. 4, the relevant coupon codes (as represented by the coupon objects 550, 568 received by the process 400) may be displayed to the user. In this manner, the relevant coupon codes are presented to the user directly so as to eliminate the need for the user to perform coupon searches, which may be inconvenient and/or time consuming.

At block 408 in FIG. 4, if the relevant coupon codes include conditions 576 (e.g., the conditional coupon object 568 is received by the process 400), then the process 400 may proceed to satisfy those conditions by moving to block 410. As described above, a coupon code condition 576 may stipulate that the total purchase value 524 of in the shopping cart must satisfy the threshold in order to qualify the user to use the coupon code. Usually, this may involve the user selecting additional products or items to purchase with the expectation that the additional products or items will satisfy the coupon code condition 576 by increasing the total value of the purchase to be greater than or equal to the threshold value. On the other hand, if the relevant coupon codes do not include coupon codes with conditions 576 that require the selection of additional products or items, then the process 400 may skip blocks 410, 412 and 414 in FIG. 4.

To suggest the additional products or items for the user, the process 400 may access other data at block 410 in FIG. 4. For example, the process 400 may retrieve and process data from the retailer 112 and the other network 116.

Based on the other data, the process 400 may determine which additional products or items should be suggested and displayed to the user at block 412 in FIG. 4. In one embodiment, the process 400 may access the retailer database 137 at the retailer 112 to suggest additional products or items that are similar to or associated with the products or items currently in the shopping cart 302. Additionally or alternatively, the process 400 may access the retailer database 137 to suggest additional products or items that are popular, top-selling, currently on sale, etc. In another embodiment, the process 400 may access both the retailer database 137 and the other databases 127 in the other network 116 to suggest additional products or items that are more personalized for the user. For example, the process 400 may access personal data (e.g., user's interests, preferences, likes/dislikes, etc.) and/or user-generated data (e.g., user's history searches, profiles, reviews, etc.) stored in the databases 127, and use those information to locate additional products or items in the retailer database 137 to suggest to the user. For example, if the user is interested in a certain genre of video gaming, then the suggested items may include video games of that genre. Accordingly, by focusing on the user's personal desires, the product suggestions may be more appealing to the user, or the user may find the product suggestions to be more useful and interesting. The number of additional products or items suggested to the user may depend on the price of the additional products or items such that if selected, the total value of the purchase including the additional products or items will be enough to satisfy the conditions of the relevant coupon codes.

At block 414 in FIG. 4, the process 400 allows the user to select the desired additional products or items in order to fulfill the coupon code conditions.

In general, one or more relevant coupon codes may be determined for the products or items in the shopping cart 302. Referring once again to FIG. 3, the web page 300 may show a product coupon code 310 that is available for a particular product in the shopping cart 302, a generic coupon code 312 that is available to any product in the shopping cart 302, and a conditional coupon code 314 that is applicable to the whole shopping cart 302. The conditional coupon code 314 also specifies the coupon code condition and lists several suggested items that the user may choose to purchase in order to satisfy the coupon code condition. In FIG. 3, the coupon codes 310-314 are displayed within the web page 300 so that the user can view and select the coupon codes without having to navigate away from the web page 300. In other embodiments, the coupon codes 310-314 may appear as links, and clicking the links may redirect the user to another web page or website to view and select the coupon codes.

While the web page 300 shows only three coupon codes 310-314, there may be more or fewer coupon codes depending on different embodiments or scenarios. In some embodiments, the web page 300 may display all available coupon codes.

Returning to the method 200 of FIG. 2, once the user satisfies the conditions of the relevant coupon codes (e.g., the user satisfies the condition 576 stipulated in the coupon code 314), the user may enter the relevant coupon codes during the checkout process at block 210. For example, with reference again to FIG. 3, the user may enter the coupon codes 310-314 into the coupon entry box 306 to receive appropriate discounts. In some embodiments, the user manually enters the coupon codes 310-314 into the box 306, while in other embodiments, the coupon codes 310-314 are placed on the clipboard of the user's computing device to be pasted into the box 306 by the user during checkout. In still other embodiments, the coupon codes 310-314 may be linked to the box 306 in the shopping cart 302. As such, the user may simply click on the coupon codes 310-314, and the coupon codes 310-314 may be automatically entered into the box 306. At block 212, the user may finish the sale transaction by completing the checkout process.

The system and method described herein for providing a coupon service during a checkout process may be well-suited to a retailer using a subscription coupon service. In particular, the coupon service can tie in with the retailer's product lines when certain coupons require the selection of additional products or items. Product suggestions of this type can lead to various sale benefits for the retailer such as increased sales, up-selling of products, customized sales, etc. Further, with the subscription service, the retailer may be motivated to include extra features with the coupon service because any extra feature can be part of a fixed monthly expense associated with the subscription service. For example, to entice customers, when the coupon service is activated, the displayed coupons may include a feature that offers a free email signup service to notify customers when new coupons become available.

Although the coupon service works well with the subscription service, the coupon service is equally applicable to a retailer using a sales commission based coupon service. That is, by activating the coupon service, one or more cookies may be set on a user's computer that associates one or more affiliates and affiliate networks with the user's online sale transaction. The set cookies allow the one or more affiliates and affiliate networks to be identified in order to receive a commission credit for the sale.

To illustrate this concept, an example affiliate referral or identification process is described herein. With reference to the Figures, the affiliate referral or identification process may begin after a user activates or selects a coupon service object 304 during a checkout process at a retailer 112. The coupon service object 304 may be provided by an affiliate 110 and included in a checkout web page 300 of a retailer website 134 associated with the retailer 112. Upon activation by the user, the coupon service object 304 may launch a request to an affiliate network 114 via an embedded URL so that the affiliate network 114 can identify the affiliate 110 to the retailer 112. This in turn also identifies the affiliate network 114 to the retailer 112. To identify the affiliate 110, the coupon service object 304 may include an identifying code or other information in the embedded URL.

Using the identifying code, the affiliate network 114 may set a value for an affiliate's cookie 144 on the user's web-enabled device 106. Similarly, the affiliate network 114 may also set a value for an affiliate network's cookie 145 on the user's web-enabled device 106. The cookies 144 and 145 act to identify the affiliate 110 and the affiliate network 114 to the retailer 112. In some implementations, the identifying code is used to generate the value for the affiliate network's cookie 145. Thus, the value for the affiliate's cookie 144 and the value for the affiliate network's cookie 145 may be different values. In other implementations, the identifying code is used as the value for the affiliate network's cookie 145. Thus, the value for the affiliate's cookie 144 and the value for the affiliate network's cookie 145 may be identical.

Back at the retailer website 134, a retailer server 122 of the retailer 112 may read one or both of the cookies 144 and 145 on the user's web-enabled device 106. If the retailer server 122 discovers the set affiliate's cookie 144, then the retailer server 122 associates an indication of the affiliate 110 with a record of any sale transaction that results at the retailer website 134. The affiliate 110 is then credited with the sale. If the retailer server 122 discovers the set affiliate network's cookie 145, then the retailer server 122 associates an indication of the affiliate network 114 with a record of any sale transaction that results at the retailer website 134. This ensures that the affiliate network 114 is able to subsequently credit the affiliate 110 with the sale. The indication of the association between the transaction record and the affiliate 110 and/or the affiliate network 114 may be stored within a memory 122A of the retailer 122, for example. From the stored indication and transaction record, the affiliate 110 and the affiliate network 114 may receive a sales commission according to terms of any agreement between the affiliate 110, the affiliate network 114, and the retailer 112. Once the user completes the sale transaction, the retailer server 122 logs the sale back to the affiliate network 114 and the affiliate network 114 may report the completed sale back to the affiliate 110. When the sale transaction has been reported to the affiliate 110, the affiliate 110 and the affiliate network 114 may earn a percentage commission on the completed sale.

On the other hand, if the cookies 144 and 145 are not set, then the retailer 112 cannot determine if the affiliate 110 or the affiliate network 114 facilitated in the transaction. As such, no credit is awarded to either parties.

This detailed description is to be construed as exemplary only and does not describe every possible embodiment, as describing every possible embodiment would be impractical, if not impossible. One could implement numerous alternate embodiments, using either current technology or technology developed after the filing date of this patent application.

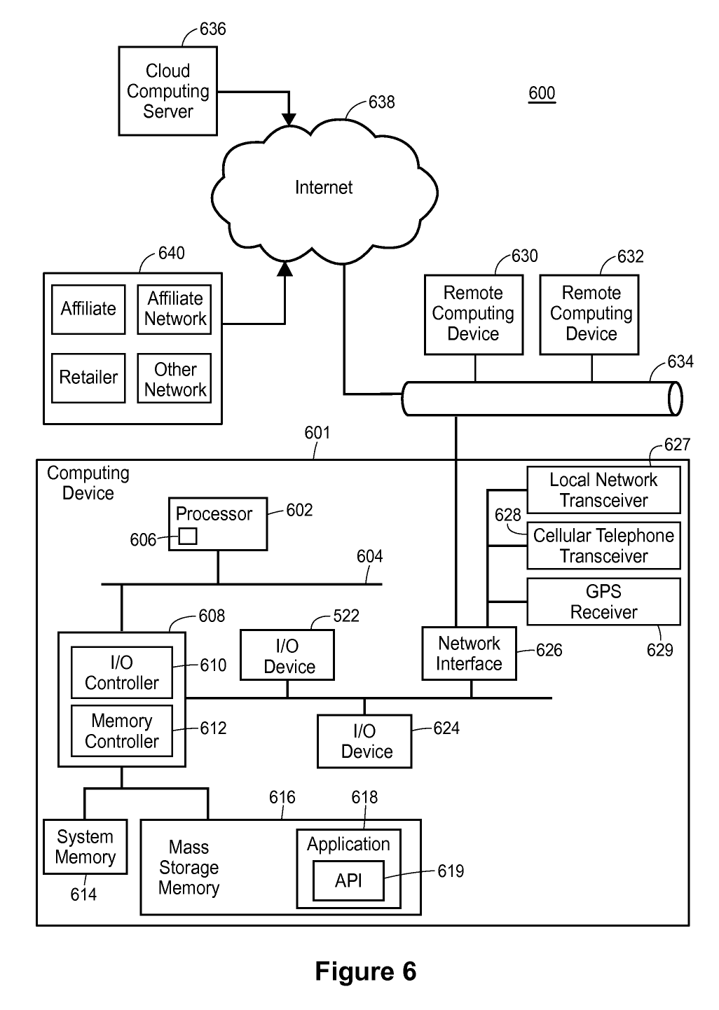

FIG. 6 is a block diagram of an example specialized computing system 600 for implementing a coupon providing system and method to provide a coupon service. In some embodiments, system 600 may include computer-executable instructions (e.g., the methods described herein) stored within one or more memories and executed using a processor to create a specialized computing device. The computing system 600 may have a specialized computing device 601 that may be used to implement the systems and methods described herein. The computing device 601 may include an affiliate 110, a retailer 112, an affiliate network 114, other network 116, and one or more web-enabled computing devices 106 (e.g., a cellular phone, a tablet computer, a thin client, a Wi-Fi-enabled device or other personal computing device capable of wireless or wired communication. As will be recognized by one skilled in the art, in light of the disclosure and teachings herein, other types of computing devices can be used that have different architectures. Processor systems similar or identical to the system 600 may be used to implement and execute the example system of FIG. 1, the methods of FIG. 2 and FIG. 4, the data structures of FIGS. 5A-5D and the like. Although the system 600 is described below as including a plurality of peripherals, interfaces, chips, memories, etc., one or more of those elements may be omitted from other example processor systems used to implement and execute the example coupon providing system 100. Also, other components may be added.

As shown in FIG. 6, the computing device 601 includes a processor 602 that is coupled to an interconnection bus 604. The processor 602 includes a register set or register space 606, which is depicted in FIG. 6 as being entirely on-chip, but which could alternatively be located entirely or partially off-chip and directly coupled to the processor 602 via dedicated electrical connections and/or via the interconnection bus 604. The processor 602 may be any suitable processor, processing unit or microprocessor. Although not shown in FIG. 6, the computing device 601 may be a multi-processor device and, thus, may include one or more additional processors that are identical or similar to the processor 602 and that are communicatively coupled to the interconnection bus 604.

The processor 602 of FIG. 6 is coupled to a chipset 608, which includes a memory controller 610 and a peripheral input/output (I/O) controller 612. As is well known, a chipset typically provides I/O and memory management functions as well as a plurality of general purpose and/or special purpose registers, timers, etc. that are accessible or used by one or more processors coupled to the chipset 608. The memory controller 610 performs functions that enable the processor 602 (or processors if there are multiple processors) to access a system memory 614 and a mass storage memory 616, that may include either or both of an in-memory cache (e.g., a cache within the memory 614) or an on-disk cache (e.g., a cache within the mass storage memory 616).

The system memory 614 may include any desired type of volatile and/or non-volatile memory such as, for example, static random access memory (SRAM), dynamic random access memory (DRAM), flash memory, read-only memory (ROM), etc. The mass storage memory 616 may include any desired type of mass storage device. For example, if the computing device 601 is used to implement an application 618 having an API 619 (including functions and instructions as described by the method 200 of FIG. 2 and the method 400 of FIG. 4). The mass storage memory 616 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible, non-transitory computer program logic or tangible and non-transitory computer executable instructions that provide the specified functionality to the computing device 601 and the computing system 600. Thus, a module, block, function, operation, procedure, routine, step, and method can be implemented in hardware, firmware, and/or software. In one embodiment, program modules and routines (e.g., the application 618, the API 619, etc.) are stored in mass storage memory 616, loaded into system memory 614, and executed by a processor 602 or can be provided from computer program products that are stored in tangible computer-readable storage mediums (e.g., RAM, hard disk, optical/magnetic media, etc.).

The peripheral I/O controller 610 performs functions that enable the processor 602 to communicate with peripheral input/output (I/O) devices 622 and 624, a network interface 626, a local network receiver 627, a cellular telephone transceiver 628, and a GPS transceiver 629 via the network interface 626. The I/O devices 622 and 624 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The cellular telephone transceiver 628 may be resident with the local network transceiver 627, for example. The local network transceiver 627 may include support for a Wi-Fi network, Bluetooth, Infrared, or other wireless data transmission protocols. In other embodiments, one element may simultaneously support each of the various wireless protocols employed by the computing device 601. For example, a software-defined radio may be able to support multiple protocols via downloadable instructions. In operation, the computing device 601 may be able to periodically poll for visible wireless network transmitters (both cellular and local network) on a periodic basis. Such polling may be possible even while normal wireless traffic is being supported on the computing device 601. The network interface 626 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 612 and the I/O controller 610 are depicted in FIG. 6 as separate functional blocks within the chipset 608, the functions performed by these blocks may be integrated within a single integrated circuit or may be implemented using two or more separate integrated circuits. The computing system 600 may also implement the application 618 on remote computing devices 630 and 632. The remote computing devices 630 and 632 may communicate with the computing device 601 over an Ethernet link 634. For example, the computing device 601 may receive data created by an application executing on a remote computing device 630, 632. In some embodiments, the application 618 may be retrieved by the computing device 601 from a cloud computing server 636 via the Internet 638. When using the cloud computing server 636, the retrieved application 618 may be programmatically linked with the computing device 601. The application 618 may be a Java® applet executing within a Java® Virtual Machine (JVM) environment resident in the computing device 601 or the remote computing devices 630, 632. The application 618 may also be “plug-ins” adapted to execute in a web-browser located on the computing devices 601, 630, and 632. In some embodiments, the application 618 may communicate with backend components 640 such as the affiliate 110, the retailer 112, the affiliate network 114 and the other network 116 via the Internet 638.

The computing system 600 may include but is not limited to any combination of a LAN, a MAN, a WAN, a mobile, a wired or wireless network, a private network, or a virtual private network. Moreover, while only two remote computing devices 630 and 632 are illustrated in FIG. 6 to simplify and clarify the description, it is understood that any number of client computers are supported and can be in communication within the system 600.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations in a specialized manner. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” means that a particular element, feature, structure, or characteristic described in connection with the embodiment is included in at least one embodiment. The appearances of the phrase “in some embodiments” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments of a system for providing a coupon service during a checkout process for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for providing a coupon service during a checkout process through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

We claim:

1. A computer-implemented method for providing a coupon service on a retailer website during a checkout process of an online sale transaction, the method comprising:
activating, at a client computing device, a clickable coupon service object included in a shopping cart application displayed at the client computing device on a web page of the retailer website;
determining, at the client computing device, one or more selected product objects displayed in the shopping cart application;
sending, from the client computing device to a coupon hosting system via a computer network, an indication of the one or more selected product objects;
receiving, at the client computing device from the client computing device via the computer network, a coupon object associated with at least one of the selected product objects of the shopping cart application; and
retrieving a coupon code corresponding to the determined coupon object.

2. The computer-implemented method of claim 1, further comprising:
displaying the retrieved coupon code on the web page at the client computing device; and
applying the retrieved coupon code associated with the selected product object of the shopping cart application during a checkout.

3. The computer-implemented method of claim 1, further comprising:
determining a condition associated with the retrieved coupon code;
retrieving data associated with the user;
accessing a retailer database to retrieve an additional product object based on the retrieved data associated with the user;
displaying the additional product object on the web page; and
satisfying the condition by adding the additional product object to the shopping cart application.

4. The computer-implemented method of claim 3, wherein retrieving data associated with the user includes retrieving data associated with the user from one or more of a social media network, a blogging network, or a customer review site.

5. The computer-implemented method of claim 3, wherein the data associated with the user includes one or more of a user interest, a user preference, a user like or dislike, a user habit, a user history search, a user profile, or a user review.

6. The computer-implemented method of claim 3, wherein the condition includes the total value of a sale transaction including the selected product object being greater than or equal to a predetermined threshold value.

7. The computer-implemented method of claim 1, wherein activating the clickable coupon service object includes redirecting the user to a web page hosted by the coupon hosting system.

8. The computer-implemented method of claim 1, further comprising retrieving a plurality of coupon codes available at the coupon hosting system and displaying the plurality of coupon codes on the web page.

9. A coupon providing system configured to provide a coupon service on a retailer website during a checkout process of an online sale transaction, the system comprising:
one or more processors;
one or more communication modules adapted to communicate data;
a program memory;
a program memory coupled to the one or more processors and storing executable instructions including a shopping cart application having selected product objects and a clickable coupon service object that is stored in the program memory and displayed on a web page of the retailer website, the clickable coupon service object when executed by the one or more processors cause the computer system to:
activate, at a client computing device, a clickable coupon service object included in a shopping cart application displayed at the client computing device on a web page of the retailer website;
determine, at the client computing device, one or more selected product objects displayed in the shopping cart application;
send, from the client computing device to a coupon hosting system via a computer network, a first data signal including an indication of the one or more selected product objects;
receive, at the client computing device from the client computing device via the computer network and in response to the first data signal, a second data signal including a coupon object associated with at least one of the selected product objects of the shopping cart application; and
retrieve a coupon code corresponding to the determined coupon object.

10. The coupon providing system of claim 9, wherein executing the clickable coupon service object further causes the processor to:
display the retrieved coupon code on the web page; and
apply the retrieved coupon code associated with the selected product object of the shopping cart application during a checkout process.

11. The coupon providing system of claim 9, wherein the system further comprises a retailer database and executing the clickable coupon service object further causes the processor to:
determine a condition associated with the retrieved coupon code;
retrieve data associated with the user;
access the retailer database to retrieve an additional product object based on the retrieved data associated with the user;
display the additional product object on the web page; and
satisfy the condition by adding the additional product object to the shopping cart application.

12. The coupon providing system of claim 11, wherein causing the processor to retrieve data associated with the user includes causing the processor to retrieve data associated with the user from one or more of a social media network, a blogging network, or a customer review site.

13. The coupon providing system of claim 11, wherein the data associated with the user includes one or more of a user interest, a user preference, a user like or dislike, a user habit, a user history search, a user profile, or a user review.

14. The coupon providing system of claim 11, wherein the condition includes the total value of a sale transaction including the selected product object being greater than or equal to a predetermined threshold value.

15. The coupon hosting system of claim 9, wherein activating the clickable coupon service object further causes the processor to redirect the user to a web page hosted by the coupon hosting system.

16. The coupon providing system of claim 9, wherein the processor retrieves a plurality of coupon codes available at the coupon hosting system and displays the plurality of coupon codes on the web page.

17. A tangible, on-transitory computer-readable medium storing instructions for providing a coupon service on a retailer website during a checkout process of an online sale transaction, the instructions when executed by at least one processor of a computing system cause the computing system to:
activate, at a client computing device, a clickable coupon service object included in a shopping cart application displayed at the client computing device on a web page of the retailer website;
determine, at the client computing device, one or more selected product objects displayed in the shopping cart application;
send, from the client computing device to a coupon hosting system via a computer network, a first data signal including an indication of the one or more selected product objects;
receive, at the client computing device from the client computing device via the computer network and in response to the first data signal, a second data signal including a coupon object associated with at least one of the selected product objects of the shopping cart application; and
retrieve a coupon code corresponding to the determined coupon object.

18. The tangible, non-transitory computer-readable medium of claim 17 further including instructions that, when executed, cause the one or more processors to:
display the retrieved coupon code on the web page; and
apply the retrieved coupon code associated with the selected product object of the shopping cart application during a checkout.

19. The tangible, non-transitory computer-readable medium of claim 17, further including instructions that, when executed, cause the one or more processors to:
determine a condition associated with the retrieved coupon code;
retrieve data associated with the user;
access a retailer database to retrieve an additional product object based on the retrieved data associated with the user;
display the additional product object on the web page; and
satisfy the condition by adding the additional product object to the shopping cart application.

20. The tangible, non-transitory computer-readable medium of claim 19, wherein causing the one or more processors to retrieve data associated with the user includes causing the one or more processors to retrieve data associated with the user from one or more of a social media network, a blogging network, or a customer review site.

21. The tangible, non-transitory computer-readable medium of claim 19, wherein the data associated with the user includes one or more of a user interest, a user preference, a user like or dislike, a user habit, a user history search, a user profile, or a user review.

22. The tangible, non-transitory computer-readable medium of claim 19, wherein the condition includes the total value of a sale transaction including the selected product object being greater than or equal to a predetermined threshold value.

23. The tangible, non-transitory computer-readable medium of claim 17, further including instructions that, when executed, cause the one or more processors to redirect the user to a web page hosted by the coupon hosting system.

24. The tangible, non-transitory computer-readable medium of claim 17, further including instructions that, when executed, cause the one or more processors to retrieve a plurality of coupon codes available at the coupon hosting system and display the plurality of coupon codes on the web page.
